(19) United States
(12) Patent Application Publication
(10) Pub. No.: US 2026/0141704 A1
(43) Pub. Date: May 21, 2026

(54) IMAGE PROCESSING METHOD AND APPARATUS, DEVICE, AND STORAGE MEDIUM

(71) Applicant: Beijing Zitiao Network Technology Co., Ltd., Beijing (CN)

(72) Inventor: Panpan XU, Beijing (CN)

(21) Appl. No.: 19/119,376

(22) PCT Filed: Sep. 28, 2023
(86) PCT No.: PCT/CN2023/122681

§ 371 Date: Apr. 8, 2025

(30) Foreign Application Priority Data
Oct. 8, 2022 (CN) 202211222407.X

(51) Int. Cl. G06V 10/82; G06N 3/0455; G06N 3/08; G06V 10/77

(52) U.S. Cl. CPC G06V 10/82; G06N 3/0455; G06N 3/08; G06V 10/7715

(57) ABSTRACT

Provided in the embodiments of the present disclosure are an image processing method and apparatus, and a device and a storage medium. The method comprises: acquiring an original image and a target state feature; and inputting the original image and the target state feature into a state transformation model, and outputting a target image, wherein a state feature of the target image matches the target state feature, and the state transformation model has a two-stage size transformation sub-network.

### CROSS-REFERENCE TO RELATED APPLICATION(S)

This application claims priority to Chinese Patent Application No. 202211222407.X, filed with the China National Intellectual Property Administration on Oct. 8, 2022, and entitled “IMAGE PROCESSING METHOD AND APPARATUS, DEVICE, AND STORAGE MEDIUM”, filed on Oct. 8, 2022, the disclosure which is incorporated by reference in its entirety.

### FIELD

Embodiments of the present disclosure relate to the technical field of image processing, and in particular, to an image processing method and apparatus, a device, and a storage medium.

### BACKGROUND

In daily photography, users have increasingly high demands for pictures. Although there are currently a large number of photo editing tools available for processing captured pictures, user requirements cannot be satisfied. States have a significant impact on the quality of the pictures. In the shooting process, the states of users or animals are often not very natural, requiring continuous attempts and repeated photography, which may possibly obtain a satisfactory state picture, but as a result, the process of acquiring pictures is low in efficiency.

### SUMMARY

Embodiments of the present disclosure provide an image processing method and apparatus, a device, and a storage medium.

In a first aspect, an embodiment of the present disclosure provides an image processing method, including:
acquiring an original image and a target state feature; and
inputting the original image and the target state feature into a state transformation model to output a target image, where a state feature of the target image matches the target state feature; and the state transformation model has two levels of size transformation subnetworks.

In a second aspect, an embodiment of the present disclosure further provides an image processing apparatus, including:
an image and feature acquiring module, configured to acquire an original image and a target state feature; and
a state transformation module, configured to input the original image and the target state feature into a state transformation model to output a target image, where a state feature of the target image matches the target state feature; and the state transformation model has two levels of size transformation subnetworks.

In a third aspect, an embodiment of the present disclosure further provides an electronic device. The electronic device includes:
one or more processors; and
a storage, configured to store one or more programs.

The one or more programs, when executed by the one or more processors, cause the one or more processors to implement the image processing method according to any embodiment of the present disclosure.

In a fourth aspect, an embodiment of the present disclosure further provides a storage medium including computer-executable instructions. The computer-executable instructions, when executed by a computer processor, are used to perform the image processing method according to any embodiment of the present disclosure.

According to the embodiments of the present disclosure, the original image and the target state feature are acquired; the original image and the target state feature are input into the state transformation model to output the target image, where the state feature of the target image matches the target state feature; and the state transformation model has the two levels of size transformation subnetworks.

### BRIEF DESCRIPTION OF THE DRAWINGS

The above and other features, advantages, and aspects of various embodiments of the present disclosure will become more apparent with reference to the accompanying drawings and the following specific implementations. Throughout the accompanying drawings, the same or similar reference numerals denote the same or similar elements. It should be understood that the accompanying drawings are illustrative, and components and elements may not necessarily be drawn to scale.

FIG. 1 is a schematic flowchart of an image processing method according to an embodiment of the present disclosure;

FIG. 2 is an example diagram of a model structure of a state transformation model according to an embodiment of the present disclosure;

FIG. 3 is a schematic flowchart of an image processing method according to an embodiment of the present disclosure;

FIG. 4 is a schematic diagram of a structure of an image processing apparatus according to an embodiment of the present disclosure; and

FIG. 5 is a schematic diagram of a structure of an electronic device according to an embodiment of the present disclosure.

### DETAILED DESCRIPTION OF EMBODIMENTS

The embodiments of the present disclosure will be described in more detail below with reference to the accompanying drawings. Although the accompanying drawings show some embodiments of the present disclosure, it should be understood that the present disclosure may be implemented in various forms, and should not be construed as being limited to the embodiments stated herein. On the contrary, these embodiments are provided for a more thorough and complete understanding of the present disclosure. It should be understood that the accompanying drawings and the embodiments of the present disclosure are for exemplary purposes only, and are not intended to limit the scope of protection of the present disclosure.

It should be understood that the steps recorded in the method implementations in the present disclosure may be performed in different orders and/or in parallel. Further, additional steps may be included and/or the execution of the illustrated steps may be omitted in the method implementations. The scope of the present disclosure is not limited in this aspect.

The term “including” used herein and variations thereof are open-ended inclusions, namely “including but not limited to”. The term “based on” is interpreted as “at least partially based on”. The term “an embodiment” means “at least one embodiment”; the term “another embodiment” means “at least one additional embodiment”; and the term “some embodiments” means “at least some embodiments”. Related definitions of other terms will be given in the description below.

It should be noted that concepts such as “first” and “second” mentioned in the present disclosure are only used to distinguish different apparatuses, modules, or units, and are not used to limit the order or relation of interdependence of functions performed by these apparatuses, modules, or units.

It should be noted that the modifiers “one” and “a plurality of” mentioned in the present disclosure are illustrative and not restrictive, and those skilled in the art should understand that unless otherwise explicitly specified in the context, the modifiers should be understood as “one or more”.

The names of messages or information exchanged between a plurality of apparatuses in the implementations of the present disclosure are used for illustrative purposes only, and are not used to limit the scope of these messages or information.

It should be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, in response to reception of an active request from the user, a prompt message is sent to the user to clearly inform the user that a requested operation will require access to and use of the personal information of the user. As such, the user can independently choose, based on the prompt message, whether to provide the personal information to software or hardware, such as an electronic device, an application, a server, or a storage medium, that performs the operations of the technical solutions of the present disclosure.

As an optional but non-limiting implementation, in response to the reception of the active request from the user, the method for sending the prompt message to the user may be, for example, a pop-up window, in which the prompt message may be presented in text. Further, the pop-up window may also carry a selection control for the user to choose whether to “agree” or “disagree” to provide the personal information to the electronic device.

It should be understood that the above notification and user authorization obtaining process is only illustrative, which does not limit the implementations of the present disclosure, and other methods that comply with the relevant laws and regulations may also be applied to the implementations of the present disclosure.

It should be understood that data (including but not limited to the data itself, and data acquisition, or usage) involved in the technical solutions should comply with the requirements of corresponding laws and regulations, and relevant stipulations.

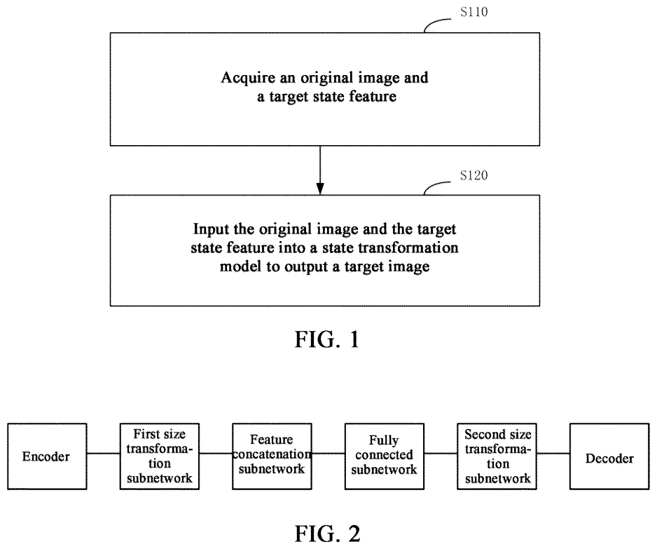

FIG. 1 is a schematic flowchart of an image processing method according to an embodiment of the present disclosure. This embodiment of the present disclosure is applicable to a case of performing a state transformation on an image. The method may be performed by an image processing apparatus. The apparatus may be implemented in the form of software and/or hardware, and is optionally implemented by an electronic device. The electronic device may be a mobile terminal, a personal computer (PC) terminal, a server, or the like.

As shown in FIG. 1, the method includes:
S110: Acquire an original image and a target state feature.

The original image may be understood as any image uploaded by a user that contains a face or a image captured in real time according to a trigger operation of the user. Exemplarily, the original image may be a image with any state. The target state feature may be understood as a state feature desired by the user. Exemplarily, it may be a state feature such as smiling, pain, and anger, which may be selected according to actual needs of the user. The target state feature may be represented using quantized tag information. Exemplarily, “0″ represents not smiling, ”1″ represents smiling, “2″ represents pain, and ”3″ represents anger.

S120: Input the original image and the target state feature into a state transformation model to output a target image.

A state feature of the target image matches the target state feature. The state transformation model has two levels of size transformation subnetworks. The two levels of size transformation subnetworks may perform a size transformation on input features respectively. The target image may be understood as an image output by the state transformation model after the state transformation. The state transformation model may be a pre-trained neural network model. The state transformation model may be used for a function of performing state transformation on the original image.

In this embodiment of the present disclosure, the original image and the target state feature may be input into the state transformation model to output the target image.

In this embodiment of the present disclosure, optionally, the step of inputting the original image and the target state feature into a state transformation model to output a target image includes: obtaining an encoded feature by performing feature encoding on the original image using an encoder; obtaining a concatenated feature by concatenating the encoded feature and the target state feature using a feature concatenation subnetwork; and performing decoding processing on the concatenated feature using a decoder to output the target image.

The state transformation model may include the encoder, the feature concatenation subnetwork, and the decoder. The encoder may be used for an operation of performing feature encoding on the image. The feature concatenation subnetwork may be used for an operation of concatenating obtained features. The decoder may be used for an operation of performing decoding processing on the feature. The encoded feature may be understood as a feature obtained after the encoder performs feature encoding on the original image. The concatenated feature may be understood as a feature obtained after the concatenation subnetwork concatenates the encoded feature and the target state feature. Specifically, the concatenation subnetwork in this embodiment of the present disclosure may be a concat network. The target image may be understood as an image obtained after the decoder performs decoding processing on the concatenated feature.

According to the setting of this embodiment of the present disclosure, the original image and the target state feature may be input into the pre-trained state transformation model, thereby obtaining the image with a target state, which is more convenient, and improving image diversity.

In this embodiment of the present disclosure, optionally, the two levels of size transformation subnetworks include: a first size transformation subnetwork and a second size transformation subnetwork; the first size transformation subnetwork is arranged between the encoder and the feature concatenation subnetwork; the second size transformation subnetwork is arranged between the first size transformation subnetwork and the decoder; a first size transformation is performed on the encoded feature using the first size transformation subnetwork; and a second size transformation is performed on the concatenated feature using the second size transformation subnetwork.

The two levels of size transformation subnetworks may include: the first size transformation subnetwork and the second size transformation subnetwork. The size transformation subnetworks may be used for an operation for transforming feature sizes.

The target state feature in this embodiment of the present disclosure may be represented by a set quantized value. Exemplarily, the state of the original image may be represented by “0”, and the target state feature may be represented by “1”. It should be understood that the target state feature is a one-dimensional structural feature.

In this embodiment of the present disclosure, since the encoded feature obtained after performing feature extraction on the original image using the encoder is an n*n matrix feature, and the target state feature is the one-dimensional structural feature, when the encoded feature and the target state feature are concatenated, the size transformation needs to be performed on the encoded feature, thereby facilitating concatenation processing.

The second size transformation subnetwork may perform the second size transformation on the concatenated feature. In this embodiment of the present disclosure, since data recognized by the decoder has an n*n structural feature, the concatenated feature, namely, the encoded feature of a vector size needs to be transformed into a feature of a matrix size to be input into the decoder to be processed. In this embodiment of the present disclosure, the target image may be an image obtained after the decoder performs decoding processing on the concatenated feature subjected to the second size transformation.

In this embodiment of the present disclosure, the first size transformation subnetwork performs the first size transformation on the encoded feature; and the second size transformation subnetwork performs the second size transformation on the concatenated feature.

According to the setting of this embodiment of the present disclosure, the size transformation may be performed on the encoded feature and the concatenated feature using the size transformation subnetworks, which facilitates the feature concatenation subnetwork to perform the concatenation processing and the decoder to perform the decoding processing, so as to output the image with the target state, thereby improving the image diversity.

In this embodiment of the present disclosure, optionally, the state transformation model further includes a fully connected subnetwork, which is arranged between the feature concatenation subnetwork and the second size transformation subnetwork; and the fully connected subnetwork is utilized for performing fully connected processing on the concatenated feature.

The fully connected subnetwork may be arranged between the feature concatenation subnetwork and the second size transformation subnetwork, and may perform a fully connected processing operation on the feature. In this embodiment, after the first size transformation subnetwork performs the size transformation on the encoded feature, the feature concatenation subnetwork may be utilized for concatenating the encoded feature and the target state feature obtained after the first size transformation, thereby obtaining the concatenated feature; and the fully connected subnetwork may be utilized for performing the fully connected processing on the concatenated feature. According to the setting of this embodiment of the present disclosure, the fully connected subnetwork may process the concatenated feature, such that the second size transformation subnetwork performs the size transformation, so as to output the image with the target state, thereby improving the image diversity.

In this embodiment of the present disclosure, the principle of the first size transformation subnetwork is to transform the encoded feature of the matrix size into the feature of the vector size. In this embodiment, since the encoded feature obtained after the encoder performs the feature encoding on the original image is represented by a matrix and the target state feature is represented by a one-dimensional vector, when the first encoded feature and the target state feature are concatenated, the size transformation needs to be performed on the encoded feature. Then, the feature concatenation subnetwork is utilized for concatenating the encoded feature obtained after the first size transformation and the target state feature, thereby obtaining the concatenated feature. The fully connected subnetwork is utilized for performing the fully connected processing on the concatenated feature. The principle of the second size transformation subnetwork is to transform the concatenated feature of the vector size into the feature of the matrix size. In this embodiment, the concatenated feature subjected to the fully connected processing using the fully connected subnetwork is represented by a one-dimensional vector, and the concatenated feature represented by the one-dimensional vector needs to be transformed into the matrix feature and then is input into the decoder.

Exemplarily, an example diagram of a model structure of the state transformation model in this embodiment of the present disclosure is shown in FIG. 2. The state transformation model may include the encoder, the first size transformation subnetwork, the feature concatenation subnetwork, the fully connected subnetwork, the second size transformation subnetwork, and the decoder.

The first size transformation subnetwork in this embodiment of the present disclosure may be arranged between the encoder and the feature concatenation subnetwork. The fully connected subnetwork may be arranged between the feature concatenation subnetwork and the second size transformation subnetwork. The second size transformation subnetwork may be arranged between the fully connected subnetwork and the decoder. The first size transformation subnetwork may be used to perform the first size transformation on the encoded feature. The concatenated feature may be obtained by concatenating the encoded feature obtained after performing the first size transformation and the target state feature using the feature concatenation subnetwork. In this embodiment of the present disclosure, the concatenated feature may be a one-dimensional structural feature. In this embodiment of the present disclosure, the fully connected subnetwork performs the fully connected processing operation on the concatenated feature.

In this embodiment of the present disclosure, the first size transformation subnetwork is utilized for performing the first size transformation on the encoded feature; the feature concatenation subnetwork is utilized for concatenating the encoded feature obtained after the first size transformation and the target state feature to obtain the concatenated feature; the fully connected subnetwork is utilized for performing the fully connected processing on the concatenated feature; the second size transformation subnetwork is utilized for performing the second size transformation on the concatenated feature obtained after the fully connected processing; and the decoder is utilized for performing the decoding processing on the concatenated feature obtained after the second size transformation, thereby outputting the target image.

According to the technical solution of this embodiment of the present disclosure, the original image and the target state feature are acquired; the original image and the target state feature are input into the state transformation model to output the target image, where the state feature of the target image matches the target state feature; and the state transformation model has the two levels of size transformation subnetworks. According to the technical solution, the state transformation model with the two levels of size transformation subnetworks performs the state transformation to generate the image with the target state, which can not only improve the image diversity, but also allow the user to acquire the image with the target state without repeated shooting of the user, thereby improving the image generation efficiency.

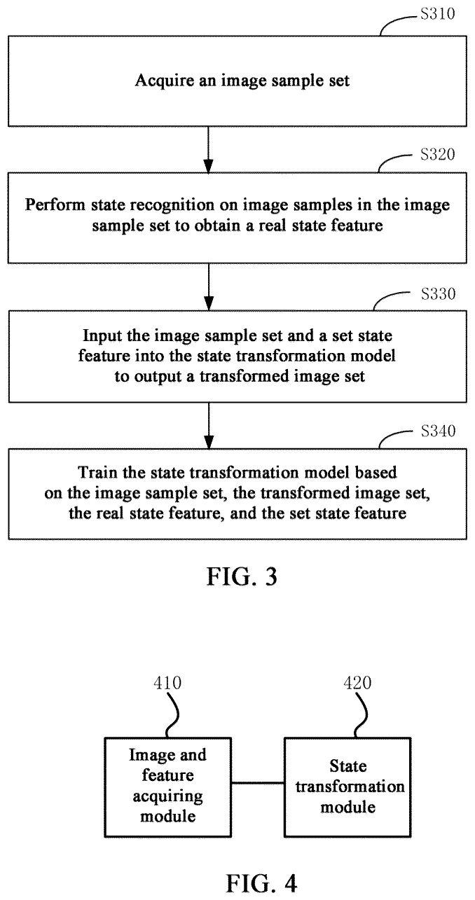

FIG. 3 is a schematic flowchart of an image processing method according to an embodiment of the present disclosure. This embodiment is optimized based on various optional solutions provided in the above embodiment, and is specifically optimized as follows: training the state transformation model includes: acquiring a image sample set; obtaining a real state feature by performing state recognition on image samples in the image sample set; inputting the image sample set and a set state feature into the state transformation model to output a transformed image set, where the set state feature and the real state feature are the same or different; and training the state transformation model based on the image sample set, the transformed image set, the real state feature, and the set state feature. As shown in FIG. 3, the method includes:
S310: Acquire a image sample set.

The image sample set may be obtained by collecting a large number of character images, including but not limited to images in different angles, different ages, and different light rays. In this embodiment of the present disclosure, the image sample set may be acquired.

S320: Obtain a real state feature by performing state recognition on image samples in the image sample set.

The state recognition may be understood as an operation of performing state recognition on the image samples in the image sample set, and specifically may be a process of classified annotation of states of the image samples in the image sample set. The state recognition may be a recognition operation manually operated, or may also be a recognition operation performed using the neural network. Exemplarily, in this embodiment of the present disclosure, the state may be recognized using a state classification model. The real state feature may be a state feature obtained after performing the state recognition on the image samples in the image sample set.

Specifically, in this embodiment of the present disclosure, the state feature may be represented by set tag information. Exemplarily, “0” may be used to represent the state feature of not smiling, “1” is used to represent the state feature of smiling, “2” may also be used to represent the state feature of pain, and “3” may also be used to represent the state feature of anger, which may be set according to needs.

In this embodiment of the present disclosure, the state recognition may be performed on the image samples in the image sample set to obtain the real state feature.

S330: Input the image sample set and the set state feature into the state transformation model to output a transformed image set.

The set state feature and the real state feature are the same or different. The set state feature may be a set state feature selected according to needs. Exemplarily, when the state in the image sample set is not smiling, in other words, “0” is used to represent the state feature of not smiling, the set state feature may be selected as “0” to represent the state feature of not smiling or “1” to represent the state feature of smiling.

The transformed image set may be output by the state transformation model, or may be a image set obtained after performing a set state feature transformation on the image sample set.

In this embodiment of the present disclosure, the image sample set and the set state feature may be input into the state transformation model to output the transformed image set.

S340: Train the state transformation model based on the image sample set, the transformed image set, the real state feature, and the set state feature.

In this embodiment of the present disclosure, the state transformation model may be trained based on the image sample set, the transformed image set, the real state feature, and the set state feature.

In this embodiment of the present disclosure, the step of training the state transformation model based on the image sample set, the transformed image set, the real state feature, and the set state feature includes:
obtaining a first feature and a second feature by respectively extracting features of the image sample set and the transformed image set; obtaining a first structural feature and a second structural feature by respectively extracting structural features of the image sample set and the transformed image set; obtaining a transformed state feature by extracting a state feature of the transformed image set; and determining a target loss function based on the image sample set, the transformed image set, the first feature, the second feature, the first structural feature, the second structural feature, the transformed state feature, and the real state feature.

The feature may be understood as a identity feature, which may be represented by a vector of a set size, such as a 1*512 vector. The first feature may be understood as a feature extracted from the image sample set; and the second feature may be understood as a feature extracted from the transformed image set. The structural features may include state information, structural information, pose information, etc. of a character, and may be multi-scale feature information. The first structural feature may be a structural feature extracted from the image sample set. The second structural feature may be a structural feature extracted from the transformed image set. The transformed state feature may be extracted from state features of a transformed state image set. In this embodiment of the present disclosure, the image feature may be extracted using a pre-trained extraction model. In this embodiment of the present disclosure, the target loss function may be determined based on the image sample set, the transformed image sample set, the first feature, the second feature, the first structural feature, the second structural feature, the transformed state feature, and the real state feature.

In this embodiment of the present disclosure, the features of the image sample set and the transformed image set may be respectively extracted to obtain the first feature and the second feature; the structural features of the image sample set and the transformed image set are respectively extracted to obtain the first structural feature and the second structural feature; the state feature of the transformed image set is extracted to obtain the transformed state feature; and the target loss function is determined based on the image sample set, the transformed image set, the first feature, the second feature, the first structural feature, the second structural feature, the transformed state feature, and the real state feature.

According to the setting of this embodiment of the present disclosure, the various features may be extracted, and the loss function is determined according to the various features, thereby facilitating training the state transformation model.

In this embodiment of the present disclosure, optionally, the determining a target loss function based on the image sample set, the transformed image set, the first feature, the second feature, the first structural feature, the second structural feature, the transformed state feature, and the real state feature includes: determining a first loss function according to the image sample set and the transformed image set; determining a second loss function according to the first feature and the second feature; determining a third loss function according to the first structural feature and the second structural feature; determining a fourth loss function according to the transformed state feature and the real state feature; determining a fifth loss function according to the transformed state feature and the set state feature; and determining at least one of the first loss function, the second loss function, the third loss function, the fourth loss function, and the fifth loss function as the target loss function.

The first loss function may represent a difference between the image sample set and the transformed image set. The second loss function may represent a difference between the first feature and the second feature. The third loss function may represent a difference between the first structural feature and the second structural feature. The fourth loss function may represent a difference between the transformed state feature and the real state feature. The fifth loss function may represent a difference between the transformed state feature and the set state feature. The target loss function may be determined based on at least one of the first loss function, the second loss function, the third loss function, the fourth loss function, and the fifth loss function. In this embodiment of the present disclosure, determination of different target loss functions may be performed according to whether the set state feature and the real state feature are the same or different.

In this embodiment of the present disclosure, the first loss function may be determined according to the image sample set and the transformed image set; the second loss function may be determined according to the first feature and the second feature; the third loss function may be determined according to the first structural feature and the second structural feature; the fourth loss function may be determined according to the transformed state feature and the real state feature; and the at least one of the first loss function, the second loss function, the third loss function, the fourth loss function, and the fifth loss function is determined as the target loss function.

According to the setting of this embodiment of the present disclosure, the target loss function may be obtained by fusing the loss functions based on the various features, which makes it more convenient to train the state transformation model and further improve the accuracy of the state transformation model.

In this embodiment of the present disclosure, optionally, the training the state transformation model based on the image sample set, the transformed image set, the real state feature, and the set state feature includes:
determining a first target loss function based on the image sample set, the transformed image set, the real state feature, and the set state feature if the set state feature and the real state feature are the same; determining a second target loss function based on the image sample set, the transformed image set, the real state feature, and the set state feature if the set state feature and the real state feature are different; and training the state transformation model according to the first target loss function and/or the second target loss function.

The first target loss function may be determined based on the image sample set, the transformed image set, the real state feature, and the set state feature when the set state feature and the real state feature are the same. The second target loss function may be determined based on the image sample set, the transformed image set, the real state feature, and the set state feature when the set state feature and the real state feature are different.

In this embodiment of the present disclosure, the state transformation model may be trained according to the first target loss function, or the state transformation model may also be trained according to the second target loss function, or the state transformation model may also be trained according to the first target loss function and the second target loss function.

The first target loss function may be obtained by fusing the first loss function, the second loss function, the third loss function, and the fourth loss function. Specifically, the fusion of the loss functions may be understood as a weighted summation operation. The first target loss function may be obtained by weighted summation of the first loss function, the second loss function, the third loss function, and the fourth loss function.

In this embodiment of the present disclosure, optionally, the determining a second target loss function based on the image sample set, the transformed image set, the real state feature, and the set state feature includes:
determining a fifth loss function according to the transformed state feature and the set state feature; and obtain the second target loss function by fusing the second loss function and the fifth loss function.

The fifth loss function may represent a difference between the transformed state feature and the set state feature. The fusion of the loss functions may be understood as a weighted summation operation. The second target loss function in this embodiment of the present disclosure may be obtained by performing the weighted summation on the second loss function and the fifth loss function.

In this embodiment of the present disclosure, the fifth loss function may be determined according to the transformed state feature and the set state feature; and the second target loss function is obtained by performing the weighted summation on the second loss function and the fifth loss function. According to the setting of this embodiment of the present disclosure, the second target loss function may be obtained by performing the weighted summation based on the loss function for representing the difference between the features, which makes it convenient to train the state transformation model and further improve the accuracy of the state transformation model.

In this embodiment of the present disclosure, the state transformation model may be trained according to the first target loss function and/or the second target loss function.

Exemplarily, training the state transformation model in this embodiment of the present disclosure may include:
first collecting a large number of character images, including but not limited to images in different angles, ages, and light rays, and classifying the images into two categories: not smiling and smiling, according to a state classification model F, where the two categories are denoted as a dataset A and a dataset B respectively;
Then, randomly selecting several pictures I from the dataset A and the dataset B during training; then, adding a one-dimensional classification label L (0, 1), where 0 represents not smiling and 1 represents smiling, performing concatenation using the concatenation subnetwork to obtain a feature vector; and finally processing using the decoder to obtain an output image D.

In this embodiment of the present disclosure, to keep the output image feature consistent with a character in an original image I, the state transformation may be controlled through the injected classification label.

Finally, in an inference stage, the generation of the smiling state may be controlled through the injected state classification label.

In this embodiment of the present disclosure, the first target loss function may be determined based on the image sample set, the transformed image set, the real state feature, and the set state feature if the set state feature and the real state feature are the same; the second target loss function may be determined based on the image sample set, the transformed image set, the real state feature, and the set state feature if the set state feature and the real state feature are different; and the state transformation model is trained according to the first target loss function and/or the second target loss function.

According to the setting of this embodiment of the present disclosure, the state transformation model may be trained based on different loss functions according to whether the set state feature and the real state feature are the same, thereby improving the accuracy and the image generation efficiency of the state transformation model.

According to the technical solution of this embodiment of the present disclosure, the image sample set is acquired; the state recognition is performed on the image samples in the image sample set to obtain the real state feature; the image sample set and the set state feature are input into the state transformation model to output the transformed image set, where the set state feature and the real state feature are the same or different; and the state transformation model is trained based on the image sample set, the transformed image set, the real state feature, and the set state feature. According to the technical solution of this embodiment of the present disclosure, by training the state transformation model through the image sample set, the transformed image set, the real state feature, and the set state feature, the image with the target state may be generated, which can not only improve the image diversity, but also allow the user to acquire the image with the target state without repeated shooting of the user, thereby improving the image generation efficiency.

FIG. 4 is a schematic diagram of a structure of an image processing unit according to an embodiment of the present disclosure. As shown in FIG. 4, the apparatus includes: an image and feature acquiring module 410 and a state transformation module 420.

The image and feature acquiring module 410 is configured to acquire an original image and a target state feature.

The state transformation model 420 is configured to input the original image and the target state feature into a state transformation model to output a target image.

A state feature of the target image matches the target state feature; and the state transformation model has two levels of size transformation subnetworks.

Optionally, the state transformation module 420 is configured to:
obtain an encoded feature by performing feature encoding on the original image using an encoder;
obtain a concatenated feature by concatenating the encoded feature and the target state feature using a feature concatenation subnetwork; and
perform decoding processing on the concatenated feature using a decoder to output the target image.

Optionally, the two levels of size transformation subnetworks include: a first size transformation subnetwork and a second size transformation subnetwork;
the first size transformation subnetwork is arranged between the encoder and the feature concatenation subnetwork; the second size transformation subnetwork is arranged between the first size transformation subnetwork and the decoder;
a first size transformation is performed on the encoded feature using the first size transformation subnetwork; and a second size transformation is performed on the concatenated feature using the second size transformation subnetwork.

Optionally, the state transformation model further includes a fully connected subnetwork, which is arranged between the feature concatenation subnetwork and the second size transformation subnetwork; and the fully connected subnetwork is utilized for performing fully connected processing on the concatenated feature.

Optionally, a training module for the state transformation model includes:
a sample set acquiring unit, configured to acquire a image sample set;
a state recognition unit, configured to obtain a real state feature by performing state recognition on image samples in the image sample set;
a state transformation unit, configured to input the image sample set and the set state feature into the state transformation model to output a transformed image set, where the set state feature and the real state feature are the same or different; and
a training unit, configured to train the state transformation model based on the image sample set, the transformed image set, the real state feature, and the set state feature.

Optionally, the training unit includes:
a feature extraction subunit, configured to obtain a first feature and a second feature by respectively extract features of the image sample set and the transformed image set;
a structural feature extraction subunit, configured to obtain a first structural feature and a second structural feature by respectively extracting structural features of the image sample set and the transformed image set;
a state feature extraction subunit, configured to obtain a transformed state feature by extracting a state feature of the transformed image set to; and
a target loss function determination subunit, configured to determine a target loss function based on the image sample set, the transformed image set, the first feature, the second feature, the first structural feature, the second structural feature, the transformed state feature, and the real state feature.

Optionally, the target loss function determination subunit is specifically configured to: determine a first loss function according to the image sample set and the transformed image set;
determine a second loss function according to the first feature and the second feature;
determine a third loss function according to the first structural feature and the second structural feature;
determine a fourth loss function according to the transformed state feature and the real state feature;
determine a fifth loss function according to the transformed state feature and the set state feature; and
determine at least one of the first loss function, the second loss function, the third loss function, the fourth loss function, and the fifth loss function as the target loss function.

The image processing unit provided in this embodiment of the present disclosure may perform the image processing method provided in any embodiment of the present disclosure, and has the corresponding functional modules and beneficial effects for performing the method.

It should be noted that the various units and modules included in the above apparatus are only divided according to functional logics, but are not limited to the above division, as long as the corresponding functions can be achieved; and in addition, the specific names of the functional units are only for the convenience of distinguishing each other, and are not used to limit the scope of protection of the embodiments of the present disclosure.

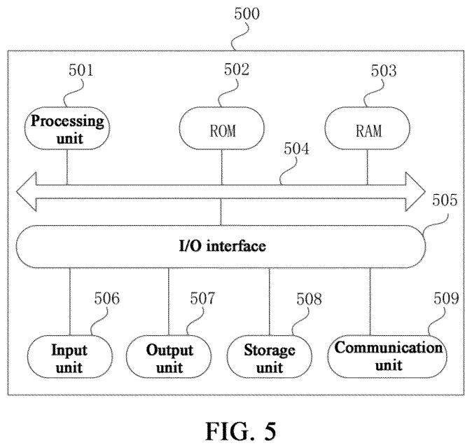

FIG. 5 is a schematic diagram of a structure of an electronic device according to an embodiment of the present disclosure. Reference is made to FIG. 5 below, which is a schematic diagram of a structure of an electronic device (e.g., a terminal device or a server in FIG. 5) 500 suitable for implementing an embodiment of the present disclosure. The terminal device in this embodiment of the present disclosure may include, but is not limited to, mobile terminals such as a mobile phone, a notebook computer, a digital broadcast receiver, a personal digital assistant (PDA), a portable Android device (PAD), a portable media player (PMP), and a vehicle-mounted terminal (e.g., a vehicle navigation terminal), and fixed terminals such as a digital TV and a desktop computer. The electronic device shown in FIG. 5 is merely an example, and should not impose any limitation on the function and scope of use of the embodiments of the present disclosure.

As shown in FIG. 5, the electronic device 500 may include a processing unit (e.g., a central processing unit and a graphics processing unit) 501, which may perform various appropriate actions and processing according to a program stored on a read-only memory (ROM) 502 or a program loaded from a storage unit 508 into a random access memory (RAM) 503. The RAM 503 further stores various programs and data required for the operation of the electronic device 500. The processing unit 501, the ROM 502, and the RAM 503 are connected to one another through a bus 504. An input/output (I/O) interface 505 is also connected to the bus 504.

Typically, the following apparatuses may be connected to the I/O interface 505: an input unit 506, including, for example, a touchscreen, a touchpad, a keyboard, a mouse, a camera, a microphone, an accelerometer, and a gyroscope; an output unit 507, including, for example, a liquid crystal display (LCD), a speaker, and a vibrator; the storage unit 508, including, for example, a magnetic tape and a hard drive; and a communication unit 509. The communication unit 509 may allow the electronic device 500 to be in wireless or wired communication with other devices for data exchange. Although FIG. 5 illustrates the electronic device 500 with various apparatuses, it should be understood that it is not necessary to implement or have all the shown apparatuses. It may be an alternative to implement or have more or fewer apparatuses.

In particular, the above process described with reference to the flowcharts according to the embodiments of the present disclosure may be implemented as a computer software program. For example, an embodiment of the present disclosure includes a computer program product, which includes a computer program carried on a non-transitory computer-readable medium, where the computer program includes program code used to perform the method shown in the flowchart. In this embodiment, the computer program may be downloaded and installed from the network through the communication unit 509, or installed from the storage unit 508, or installed from the ROM 502. The computer program, when executed by the processing unit 501, performs the above functions limited in the method in this embodiment of the present disclosure.

The names of messages or information exchanged between a plurality of apparatuses in the implementations of the present disclosure are used for illustrative purposes only, and are not used to limit the scope of these messages or information.

The electronic device provided in this embodiment of the present disclosure and the image processing method provided in the above embodiment belong to the same inventive concept, and for technical details not described in detail in this embodiment, reference may be made to the above embodiment. This embodiment and the above embodiment have the same beneficial effects.

An embodiment of the present disclosure provides a computer storage medium, storing a computer program. The program, when executed by a processor, implements the image processing method provided in the above embodiment.

It should be noted that the above computer-readable medium described in the present disclosure may be a computer-readable signal medium, or a computer-readable storage medium, or any combination of the above. The computer-readable storage medium may be, for example, but is not limited to, electric, magnetic, optical, electromagnetic, infrared, or semiconductor systems, apparatuses, or devices, or any combination of the above. More specific examples of the computer-readable storage medium may include, but are not limited to: an electrical connection with one or more wires, a portable computer disk, a hard drive, a random access memory (RAM), a read-only memory (ROM), an erasable programmable read-only memory (EPROM or a flash memory), an optical fiber, a portable compact disk read-only memory (CD-ROM), an optical storage device, a magnetic storage device, or any suitable combination of the above. In the present disclosure, the computer-readable storage medium may be any tangible medium including or storing a program, and the program may be used by or in combination with an instruction execution system, apparatus, or device. However, in the present disclosure, the computer-readable signal medium may include a data signal propagated in a baseband or as a part of a carrier, where the data signal carries computer-readable program code. The propagated data signal may take various forms, including but not limited to an electromagnetic signal, an optical signal, or any suitable combination of the above. The computer-readable signal medium may also be any computer-readable medium other than the computer-readable storage medium. The computer-readable signal medium may send, propagate, or transmit a program used by or in combination with the instruction execution system, apparatus, or device. The program code included in the computer-readable medium may be transmitted by any suitable medium, including but not limited to a wire, an optical cable, radio frequency (RF), etc., or any suitable combination of the above.

In some implementations, a client and a server may communicate using any currently known or future-developed network protocols such as a hypertext transfer protocol (HTTP), and may be interconnected with digital data communication in any form or medium (e.g., a communication network). Examples of the communication network include a local area network (“LAN”), a wide area network (“WAN”), an internetwork (e.g., the Internet), a peer-to-peer network (e.g., an ad hoc peer-to-peer network), and any currently known or future-developed network.

The computer-readable medium may be included in the above electronic device; or may also separately exist without being assembled in the electronic device.

The above computer-readable medium carries one or more programs. The one or more programs, when executed by the electronic device, cause the electronic device to:
The above computer-readable medium carries one or more programs. The one or more programs, when executed by the electronic device, cause the electronic device to: acquire an original image and a target state feature; and
input the original image and the target state feature into a state transformation model to output a target image, where a state feature of the target image matches the target state feature.

Computer program code for performing operations of the present disclosure may be written in one or more programming languages or a combination thereof, where the above programming languages include, but are not limited to, object-oriented programming languages, such as Java, Smalltalk, and C++, and further include conventional procedural programming languages, such as “C” language or similar programming languages. The program code may be executed entirely on a user computer, partly on the user computer, as a stand-alone software package, partly on the user computer and partly on a remote computer, or entirely on the remote computer or the server. In the case of involving the remote computer, the remote computer may be connected to the user computer through any type of network, including a local area network (LAN) or a wide area network (WAN), or may be connected to an external computer (e.g., utilizing an Internet service provider for Internet connectivity).

The flowcharts and the block diagrams in the accompanying drawings illustrate the possibly implemented system architecture, functions, and operations of the system, the method, and the computer program product according to the various embodiments of the present disclosure. In this regard, each block in the flowcharts or the block diagrams may represent a module, a program segment, or a part of code, and the module, the program segment, or the part of code contains one or more executable instructions for implementing specified logical functions. It should also be noted that in some alternative implementations, the functions marked in the blocks may also occur in an order different from that marked in the accompanying drawings. For example, two blocks shown in succession may actually be performed substantially in parallel, or may sometimes be performed in a reverse order, depending on the functions involved. It should also be noted that each block in the block diagrams and/or the flowcharts, and a combination of the blocks in the block diagrams and/or the flowcharts may be implemented by using a dedicated hardware-based system that performs specified functions or operations, or may be implemented by using a combination of dedicated hardware and computer instructions.

The related units described in the embodiments of the present disclosure may be implemented by software or hardware. Names of the units do not constitute a limitation on the units themselves in some cases. For example, a first acquiring unit may alternatively be described as “a unit for acquiring at least two Internet protocol addresses”.

Herein, the functions described above may be at least partially executed by one or more hardware logic components. For example, without limitation, exemplary hardware logic components that can be used include: a field-programmable gate array (FPGA), an application specific integrated circuit (ASIC), an application specific standard part (ASSP), a system on chip (SOC), a complex programmable logic device (CPLD), etc.

In the context of the present disclosure, a machine-readable medium may be a tangible medium that may include or store a program used by or in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above content. More specific examples of the machine-readable storage medium may include an electrical connection based on one or more wires, a portable computer disk, a hard drive, a random access memory (RAM), a read-only memory (ROM), an erasable programmable read-only memory (EPROM or a flash memory), an optical fiber, a portable compact disk read-only memory (CD-ROM), an optical storage device, a magnetic storage device, or any suitable combination of the above content.

According to one or more embodiments of the present disclosure, an image processing method is provided and includes:
acquiring an original image and a target state feature; and
inputting the original image and the target state feature into a state transformation model to output a target image, where a state feature of the target image matches the target state feature; and the state transformation model has two levels of size transformation subnetworks.

Optionally, the inputting the original image and the target state feature into a state transformation model to output a target image includes:
obtaining an encoded feature by performing feature encoding on the original image using an encoder;
obtain a concatenated feature by concatenating the encoded feature and the target state feature using a feature concatenation subnetwork; and
performing decoding processing on the concatenated feature using a decoder to output the target image.

Optionally, the two levels of size transformation subnetworks include: a first size transformation subnetwork and a second size transformation subnetwork;

the first size transformation subnetwork is arranged between the encoder and the feature concatenation subnetwork; the second size transformation subnetwork is arranged between the first size transformation subnetwork and the decoder;
a first size transformation is performed on the encoded feature using the first size transformation subnetwork; and
a second size transformation is performed on the concatenated feature using the second size transformation subnetwork.

Optionally, the state transformation model further includes a fully connected subnetwork, which is arranged between the feature concatenation subnetwork and the second size transformation subnetwork; and the fully connected subnetwork is utilized for performing fully connected processing on the concatenated feature.

Optionally, training the state transformation model includes:
acquiring a image sample set;
obtain a real state feature by performing state recognition on image samples in the image sample set;
inputting the image sample set and a set state feature into the state transformation model to output a transformed image set, where the set state feature and the real state feature are the same or different; and
training the state transformation model based on the image sample set, the transformed image set, the real state feature, and the set state feature.

Optionally, the training the state transformation model based on the image sample set, the transformed image set, the real state feature, and the set state feature includes:
obtaining a first feature and a second feature by respectively extracting features of the image sample set and the transformed image set;
obtain a first structural feature and a second structural feature by respectively extracting structural features of the image sample set and the transformed image set;
obtaining a transformed state feature by extracting a state feature of the transformed image set; and
determining a target loss function based on the image sample set, the transformed image set, the first feature, the second feature, the first structural feature, the second structural feature, the transformed state feature, and the real state feature.

Optionally, the determining a target loss function based on the image sample set, the transformed image set, the first feature, the second feature, the first structural feature, the second structural feature, the transformed state feature, and the real state feature includes:
determining a first loss function according to the image sample set and the transformed image set;
determining a second loss function according to the first feature and the second feature;
determining a third loss function according to the first structural feature and the second structural feature;
determining a fourth loss function according to the transformed state feature and the real state feature;
determining a fifth loss function according to the transformed state feature and the set state feature; and
determining at least one of the first loss function, the second loss function, the third loss function, the fourth loss function, and the fifth loss function as the target loss function.

What are described above are only preferred embodiments of the present disclosure and explanations of the technical principles applied. Those skilled in the art should understand that the scope of the disclosure involved in the present disclosure is not limited to the technical solutions formed by specific combinations of the above technical features, and shall also cover other technical solutions formed by any combination of the above technical features or equivalent features thereof without departing from the above concept of disclosure, such as a technical solution formed by replacing the above features with the technical features with similar functions disclosed (but not limited to) in the present disclosure.

Further, although the operations are described in a particular order, it should not be understood as requiring these operations to be performed in the shown particular order or in a sequential order. In certain environments, multitasking and parallel processing may be advantageous. Similarly, although several specific implementation details are included in the above discussion, these specific implementation details should not be interpreted as limitations on the scope of the present disclosure. Some features that are described in the context of separate embodiments may also be implemented in combination in a single embodiment. In contrast, various features described in the context of a separate embodiment may alternatively be implemented in a plurality of embodiments individually or in any suitable subcombination.

Although the subject matter has been described in a language specific to structural features and/or logic actions of the method, it should be understood that the subject matter defined in the appended claims is not necessarily limited to the specific features or actions described above. On the contrary, the specific features and the actions described above are merely example forms for implementing the claims.

1. An image processing method, comprising:
acquiring an original image and a target state feature; and
inputting the original image and the target state feature into a state transformation model to output a target image, wherein a state feature of the target image matches the target state feature; and the state transformation model has two levels of size transformation subnetworks.

2. The method of claim 1, wherein inputting the original image and the target state feature into the state transformation model to output the target image comprises:
obtaining an encoded feature by performing feature encoding on the original image using an encoder;
obtaining a concatenated feature by concatenating the encoded feature and the target state feature using a feature concatenation subnetwork; and
performing decoding processing on the concatenated feature using a decoder to output the target image.

3. The method of claim 2, wherein the two levels of size transformation subnetworks comprise a first size transformation subnetwork and a second size transformation subnetwork;
the first size transformation subnetwork is arranged between the encoder and the feature concatenation subnetwork; the second size transformation subnetwork is arranged between the first size transformation subnetwork and the decoder;
a first size transformation is performed on the encoded feature using the first size transformation subnetwork; and
a second size transformation is performed on the concatenated feature using the second size transformation subnetwork.

4. The method of claim 3, wherein the state transformation model further comprises a fully connected subnetwork, the fully connected subnetwork is arranged between the feature concatenation subnetwork and the second size transformation subnetwork; and the fully connected subnetwork is utilized for performing fully connected processing on the concatenated feature.

5. The method of claim 1, wherein training the state transformation model comprises:
acquiring a image sample set;
obtaining a real state feature by performing state recognition on image samples in the image sample set;
inputting the image sample set and a set state feature into the state transformation model to output a transformed image set, wherein the set state feature and the real state feature are the same or different; and
training the state transformation model based on the image sample set, the transformed image set, the real state feature, and the set state feature.

6. The method of claim 5, wherein training the state transformation model based on the image sample set, the transformed image set, the real state feature, and the set state feature comprises:
obtaining a first feature and a second feature by respectively extracting features of the image sample set and the transformed image set;
obtaining a first structural feature and a second structural feature by respectively extracting structural features of the image sample set and the transformed image set;
obtaining a transformed state feature by extracting a state feature of the transformed image set; and
determining a target loss function based on the image sample set, the transformed image set, the first feature, the second feature, the first structural feature, the second structural feature, the transformed state feature, and the real state feature.

7. The method of claim 6, wherein the determining of the target loss function based on the image sample set, the transformed image set, the first feature, the second feature, the first structural feature, the second structural feature, the transformed state feature, and the real state feature comprises:
determining a first loss function according to the image sample set and the transformed image set;
determining a second loss function according to the first feature and the second feature;
determining a third loss function according to the first structural feature and the second structural feature;
determining a fourth loss function according to the transformed state feature and the real state feature;
determining a fifth loss function according to the transformed state feature and the set state feature; and
determining at least one of the first loss function, the second loss function, the third loss function, the fourth loss function, and the fifth loss function as the target loss function.

8. (canceled)

9. An electronic device, comprising:
one or more processors; and
a storage, configured to store one or more programs, wherein the one or more programs, when executed by the one or more processors, cause the one or more processors to:
acquire an original image and a target state feature; and
input the original image and the target state feature into a state transformation model to output a target image, wherein a state feature of the target image matches the target state feature;
and the state transformation model has two levels of size transformation subnetworks.

10. A non-transitory storage medium comprising computer-executable instructions, wherein the computer-executable instructions, when executed by a computer processor, cause the computer processor to:
acquire an original image and a target state feature; and
input the original image and the target state feature into a state transformation model to output a target image, wherein a state feature of the target image matches the target state feature; and the state transformation model has two levels of size transformation subnetworks.

11. (canceled)

12. The electronic device of claim 9, wherein the one or more programs that cause the one or more processors to input the original image and the target state feature into the state transformation model to output the target image comprise instructions to:
obtain an encoded feature by performing feature encoding on the original image using an encoder;
obtain a concatenated feature by concatenating the encoded feature and the target state feature using a feature concatenation subnetwork; and
perform decoding processing on the concatenated feature using a decoder to output the target image.

13. The electronic device of claim 12, wherein the two levels of size transformation subnetworks comprise a first size transformation subnetwork and a second size transformation subnetwork;
the first size transformation subnetwork is arranged between the encoder and the feature concatenation subnetwork; the second size transformation subnetwork is arranged between the first size transformation subnetwork and the decoder;
a first size transformation is performed on the encoded feature using the first size transformation subnetwork; and
a second size transformation is performed on the concatenated feature using the second size transformation subnetwork.

14. The electronic device of claim 13, wherein the state transformation model further comprises a fully connected subnetwork, the fully connected subnetwork is arranged between the feature concatenation subnetwork and the second size transformation subnetwork;
and the fully connected subnetwork is utilized for performing fully connected processing on the concatenated feature.

15. The electronic device of claim 9, wherein the one or more processors is further caused to train the state transformation model by:
acquiring a image sample set;
obtaining a real state feature by performing state recognition on image samples in the image sample set;
inputting the image sample set and a set state feature into the state transformation model to output a transformed image set, wherein the set state feature and the real state feature are the same or different; and
training the state transformation model based on the image sample set, the transformed image set, the real state feature, and the set state feature.

16. The electronic device of claim 15, wherein the one or more programs that cause the one or more processors to train the state transformation model based on the image sample set, the transformed image set, the real state feature, and the set state feature comprise instructions to:
obtain a first feature and a second feature by respectively extracting features of the image sample set and the transformed image set;
obtain a first structural feature and a second structural feature by respectively extracting structural features of the image sample set and the transformed image set;
obtain a transformed state feature by extracting a state feature of the transformed image set; and
determine a target loss function based on the image sample set, the transformed image set, the first feature, the second feature, the first structural feature, the second structural feature, the transformed state feature, and the real state feature.

17. The electronic device of claim 16, wherein the one or more programs that cause the one or more processors to determine the target loss function based on the image sample set, the transformed image set, the first feature, the second feature, the first structural feature, the second structural feature, the transformed state feature, and the real state feature comprise instructions to:
determine a first loss function according to the image sample set and the transformed image set;
determine a second loss function according to the first feature and the second feature;
determine a third loss function according to the first structural feature and the second structural feature;
determine a fourth loss function according to the transformed state feature and the real state feature;
determine a fifth loss function according to the transformed state feature and the set state feature; and
determine at least one of the first loss function, the second loss function, the third loss function, the fourth loss function, and the fifth loss function as the target loss function.

18. The non-transitory storage medium of claim 10, wherein the computer-executable instructions that cause the computer processor to input the original image and the target state feature into the state transformation model to output the target image comprise instructions to:
obtain an encoded feature by performing feature encoding on the original image using an encoder;
obtain a concatenated feature by concatenating the encoded feature and the target state feature using a feature concatenation subnetwork; and
perform decoding processing on the concatenated feature using a decoder to output the target image.

19. The non-transitory storage medium of claim 18, wherein the two levels of size transformation subnetworks comprise a first size transformation subnetwork and a second size transformation subnetwork;
the first size transformation subnetwork is arranged between the encoder and the feature concatenation subnetwork; the second size transformation subnetwork is arranged between the first size transformation subnetwork and the decoder;
a first size transformation is performed on the encoded feature using the first size transformation subnetwork; and
a second size transformation is performed on the concatenated feature using the second size transformation subnetwork.

20. The non-transitory storage medium of claim 10, wherein the computer processor is further caused to train the state transformation model by:
acquiring a image sample set;
obtaining a real state feature by performing state recognition on image samples in the image sample set;
inputting the image sample set and a set state feature into the state transformation model to output a transformed image set, wherein the set state feature and the real state feature are the same or different; and
training the state transformation model based on the image sample set, the transformed image set, the real state feature, and the set state feature.

21. The non-transitory storage medium of claim 20, wherein the computer-executable instructions that cause the computer processor to train the state transformation model based on the image sample set, the transformed image set, the real state feature, and the set state feature comprise instructions to:
obtain a first feature and a second feature by respectively extracting features of the image sample set and the transformed image set;
obtain a first structural feature and a second structural feature by respectively extracting structural features of the image sample set and the transformed image set;
obtain a transformed state feature by extracting a state feature of the transformed image set; and
determine a target loss function based on the image sample set, the transformed image set, the first feature, the second feature, the first structural feature, the second structural feature, the transformed state feature, and the real state feature.

22. The non-transitory storage medium of claim 21, wherein the computer-executable instructions that cause the computer processor to determine the target loss function based on the image sample set, the transformed image set, the first feature, the second feature, the first structural feature, the second structural feature, the transformed state feature, and the real state feature comprise instructions to:
determine a first loss function according to the image sample set and the transformed image set;
determine a second loss function according to the first feature and the second feature;
determine a third loss function according to the first structural feature and the second structural feature;
determine a fourth loss function according to the transformed state feature and the real state feature;
determine a fifth loss function according to the transformed state feature and the set state feature; and
determine at least one of the first loss function, the second loss function, the third loss function, the fourth loss function, and the fifth loss function as the target loss function.
